(19) United States
(12) Patent Application Publication
(10) Pub. No.: US 2025/0187592 A1
(43) Pub. Date: Jun. 12, 2025

(54) AUTONOMOUS EMERGENCY BRAKING METHOD BASED ON MAP DATA

(71) Applicant: HL KLEMOVE CORP., Incheon (KR)

(72) Inventor: Jung Keuk KIM, Incheon (KR)

(21) Appl. No.: 18/769,290

(22) Filed: Jul. 10, 2024

(30) Foreign Application Priority Data
Dec. 11, 2023 (KR) 10-2023-0178644

(51) Int. Cl. B60W 30/09; B60T 7/12; B60T 8/171

(52) U.S. Cl. CPC B60W 30/09; B60T 7/12; B60T 8/171; B60W 2710/18

(57) ABSTRACT

In an autonomous emergency braking method based on map data of the present disclosure, warning and braking may be performed based on different standards depending on a pavement condition of the road and a braking time point may be turned according to a road pavement condition.

In addition, the present disclosure enables a sensitive operation and filtering exception processing for a target that occurs frequently or requires additional attention in driving road conditions.

### TECHNICAL FIELD

The present disclosure relates to an autonomous emergency braking method based on map data, and more particularly, to an autonomous emergency braking method based on map data capable of implementing autonomous emergency braking according to various road environments using map data and reducing the risk of erroneous control of autonomous emergency braking by lowering the possibility of target misrecognition.

### BACKGROUND

Autonomous emergency braking (AEB) device is a type of advanced driving assistance device installed in automobiles. As can be seen from its name, the autonomous emergency braking (AEB) device is a device that directly slows down or puts on the emergency brake, while a vehicle makes warning sound, even without driver's putting on the brake, when the driver is neglectful of keeping eyes forward or drives while drowsy or cannot handle a situation with a human's reaction speed in the event of detecting a threat of an accident ahead,

The autonomous emergency braking system operates by detecting obstacles in front of the vehicle and then braking. The autonomous emergency braking systems are classified into four types: \textcircled{1} radar/camera type, \textcircled{2} camera type, \textcircled{3} radar type, and \textcircled{4} lidar type depending on how the vehicle recognizes a preceding vehicle. The autonomous emergency braking system may make only a warning sound or be deactivated in situations, such as when an accelerator is pressed, when the vehicle may be re-accelerated by evading system intervention, or when the vehicle is waiting for a signal.

In a state in which the autonomous emergency braking system detects danger and performs braking or evasive maneuvers, if the driver steps on the accelerator again or holds on to a steering wheel all the way, the autonomous emergency braking system may determine that it is an error in the vehicle sensor and be released.

According to the autonomous emergency braking method according to the related art, since a pavement level of a road on which the vehicle is traveling is unknown, the autonomous emergency braking device operates on the same basis even if the pavement level of the road is different.

Accordingly, there is a problem in that a braking distance occurs to be different even in the same scenario using the same software and hardware.

In addition, according to the autonomous emergency braking method of the related art, in situations, such as right before entering a curved road, autonomous emergency braking requirements may be different from those on a regular road.

In addition, in child protection zones, etc., caution is required for child pedestrian targets, and sensitive braking may be required for those targets.

This scenario has the problem of making it impossible to determine because only data from sensors installed in the vehicle is used.

In addition, according to the autonomous emergency braking method of the related art, there is a possibility that a malfunction may occur for a scenario that cannot be implemented on the road while driving.

In other words, there is a problem in which a risk may be determined even in risk scenarios that are impossible or have a very low occurrence frequency in driving road conditions, and autonomous emergency braking may malfunction due to misrecognition of pedestrians, bicycle targets, etc. on the highway.

### SUMMARY

In view of the above, the present disclosure provides an autonomous emergency braking method based on map data, capable of implementing autonomous emergency braking according to various road environments using map data and reducing the risk of erroneous control of autonomous emergency braking by lowering the possibility of target misrecognition.

The present disclosure provides an autonomous emergency braking method based on map data, wherein a controller receives information (target data) of a control target for autonomous emergency braking through sensor data from a sensor mounted in a vehicle, receives real-time driving road type information (current road type) through map data (map/navigation) mounted in the vehicle, classifies the control target according to a driving road type of the map data, selects an autonomous emergency braking control target, performs a collision prediction on the selected autonomous emergency braking control target data based on time-to-collision (TTC), calculates a collision TTC (TTC_{c}) with a target through dynamic information including a relative distance to the selected autonomous emergency braking control target and a relative speed, compares the calculated collision TTC (TTC_{c}) with the target with a preset risk determination reference TTC (TTC_{w}), determines a risk when the collision TTC (TTC_{c}) with the target is smaller than the risk determination reference TTC (TTC_{w}), and issues a warning and braking command.

The controller may classify the control target into a general target, a priority target, and a target with a low possibility of occurrence according to the driving road type.

When the control target is the general target, the controller may filter data of the control target and determine whether the control target is a normal autonomous emergency braking control target, and when the control target is determined to be the normal autonomous emergency braking control target, the controller may perform autonomous emergency braking control target selection.

When the control target is the priority target, the controller may alleviate data filtering of the control target and determine whether the control target is a normal autonomous emergency braking control target, and when the control target is determined to be the normal autonomous emergency braking control target, the controller may perform autonomous emergency braking control target selection.

When the control target is the target with a low possibility of occurrence, the controller may strengthen data filtering of the control target (adds a target selection filter) and determines whether the control target is a normal autonomous emergency braking control target, and when the control target is determined to be the normal autonomous emergency braking control target, the controller may perform autonomous emergency braking control target selection.

The controller may classify the driving road into a dangerous road and a general road according to the risk determination reference (TTC) (TTC_{w}) based on the selected autonomous emergency braking control target data.

When the driving road is the dangerous road, the controller may set a warning time point to be earlier than that of the general road by adding a tuning value F to the risk determination reference TTC (TTC_{w}).

When the driving road is the general road, the controller may classify the selected autonomous emergency braking control target into a priority target and a general target.

When the selected autonomous emergency braking control target is the priority target, the controller may set a warning time point to be earlier than that of the general target by adding a tuning value F to the risk determination reference TTC (TTC_{w}).

The present disclosure also provides an autonomous emergency braking method based on map data, wherein a controller receives information (target data) of a control target for autonomous emergency braking through sensor data from a sensor mounted in a vehicle, receives real-time driving road type information (current road type) through map data (map/navigation) mounted in the vehicle, and classifies the control target into a general target, a priority target, and a target with a low possibility of occurrence according to the driving road type, and when the control target is a priority target, the controller alleviates data filtering of the control target and determines whether the control target is a normal autonomous emergency braking control target, and when the control target is determined to be a normal autonomous emergency braking control target, the controller performs autonomous emergency braking control target selection.

The controller may perform collision prediction on the selected autonomous emergency braking control target data based on time-to-collision (TTC), calculate a collision TTC (TTC_{c}) with a target through dynamic information including a relative distance to the selected autonomous emergency braking control target and a relative speed, and compare the calculated collision TTC (TTC_{c}) with the target with a preset risk determination reference TTC (TTC_{w}), and when the collision TTC (TTC_{c}) with the target is smaller than the risk determination reference TTC (TTC_{w}), the controller may determine it as a risk and issues a warning and braking command.

The controller may classify the driving road into a dangerous road and a general road according to the risk determination reference TTC (TTC_{w}) based on the selected autonomous emergency braking control target data, and when the driving road is the dangerous road, the controller may set a warning time point to be earlier than that of the general road by adding a tuning value F to the risk determination reference TTC (TTC_{w}).

When the driving road is a general road, the controller may classify the selected autonomous emergency braking control target into a priority target and a general target, and when the selected autonomous emergency braking control target is the priority target, the controller may set the warning time point to be earlier than that of the general target by adding a tuning value F to the risk determination reference TTC (TTC_{w}).

The present disclosure also provides an autonomous emergency braking method based on map data, wherein a controller receives information (target data) of a control target for autonomous emergency braking through sensor data from a sensor mounted in a vehicle, receives real-time driving road type information (current road type) through map data (map/navigation) mounted in the vehicle, classifies the control target into a general target, a priority target, and a target with a low possibility of occurrence according to the driving road type, and when the control target is the target with a low possibility of occurrence, the controller strengthens data filtering of the control target (adds a target selection filter) and determines whether the control target is a normal autonomous emergency braking control target, and when the control target is determined to be the normal autonomous emergency braking control target, the controller performs autonomous emergency braking control target selection.

The controller may perform a collision prediction on the selected autonomous emergency braking control target data based on time-to-collision (TTC), calculate a collision TTC (TTC_{c}) with a target through dynamic information including a relative distance to the selected autonomous emergency braking control target and a relative speed, compare the calculated collision TTC (TTC_{c}) with the target with a preset risk determination reference TTC (TTC_{w}), determine a risk when the collision TTC (TTC_{c}) with the target is smaller than the risk determination reference TTC (TTC_{w}), and issue a warning and braking command.

The controller may classify the driving road into a dangerous road and a general road according to the risk determination reference TTC (TTC_{w}) based on the selected autonomous emergency braking control target data, and when the driving road is the dangerous road, the controller may set a warning time point to be earlier than that of the general road by adding a tuning value F to the risk determination reference TTC (TTC_{w}).

When the driving road is a general road, the controller may classify the selected autonomous emergency braking control target into a priority target and a general target, and when the selected autonomous emergency braking control target is the priority target, the controller may set the warning time point to be earlier than that of the general target by adding a tuning value F to the risk determination reference TTC (TTC_{w}).

Details of other embodiments are included in “Descriptions for carrying out the present disclosure” and the accompanying “drawings.”

Advantages and/or features of the present invention, and a method for achieving the same will become apparent with reference to various embodiments described below as well as the accompanying drawings.

However, the present invention is not limited only to the configuration of each embodiment disclosed below, but may be implemented in various different forms, and only each embodiment disclosed in the present specification makes the disclosure of the present invention complete. Further, it should be understood that the present invention is provided to completely inform the scope of the present invention to those skilled in the art, and the present invention is only defined by the scope of each of the appended claims

According to the solution problems, the present disclosure has the following effects.

The present disclosure has the effect of enabling warning and braking based on different standards depending on a pavement condition of the road and tuning a braking time point according to a road pavement condition.

In addition, the present disclosure has the effect of enabling a sensitive operation and filtering exception processing for a target that occurs frequently or requires additional attention in driving road conditions.

In addition, the present disclosure has the effect of reducing the rate of misrecognition by handling dangerous scenarios that are impossible or occur very rarely in driving road conditions (e.g., crossing targets on straight roads, pedestrian targets on highways, etc.) as exceptions, upon misrecognition thereof.

Accordingly, the risk of erroneous control of autonomous emergency braking may be reduced.

### BRIEF DESCRIPTION OF THE DRAWINGS

FIG. 1 is a flowchart illustrating a control target selection process in a general autonomous emergency braking method.

FIG. 2 is a diagram illustrating an example of control target selection in a general autonomous emergency braking method.

FIG. 3 is a flowchart illustrating a general autonomous emergency braking method.

FIG. 4 is a flowchart illustrating a control target selection process in an autonomous emergency braking method based on map data according to the present disclosure.

FIG. 5 is a diagram illustrating an example of control target selection in an autonomous emergency braking method based on map data according to the present disclosure.

FIG. 6 is a diagram illustrating another example of control target selection in an autonomous emergency braking method based on map data according to the present disclosure.

FIG. 7 is a flowchart illustrating an autonomous emergency braking method based on map data according to the present disclosure.

FIG. 8 is a schematic configuration diagram of a system for implementing an autonomous emergency braking method based on map data according to the present disclosure.

### DETAILED DESCRIPTION

Hereinafter, an embodiment of an autonomous emergency braking method based on map data according to the present disclosure is described in detail based on the accompanying drawings. For reference, terms and words used in the present specification and claims to be described below should not be construed as limited to ordinary or dictionary terms, and should be construed in accordance with the technical idea of the present disclosure based on the principle that the inventors may properly define their own inventions in terms of terms in order to best explain the invention. Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

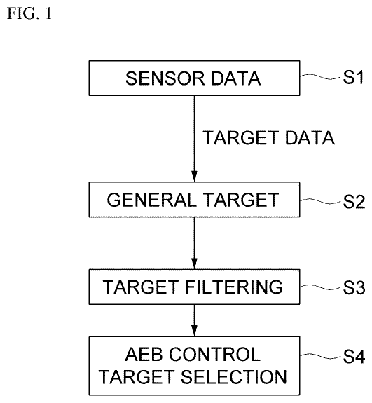

FIG. 1 is a flowchart illustrating a control target selection process in a general autonomous emergency braking method.

In the autonomous emergency braking method as shown in FIG. 1, the control target selection process is implemented by a controller in which a program configured to receive information on a control target for autonomous emergency braking (target data) through sensor data from a sensor mounted on the vehicle (S1), setting it as a general target (S2), perform filtering (target filter) (S3), determining whether it is a normal autonomous emergency braking (AEB) control target, and selecting as autonomous emergency braking control target (S4) when it is determined as normal autonomous emergency braking control target is installed.

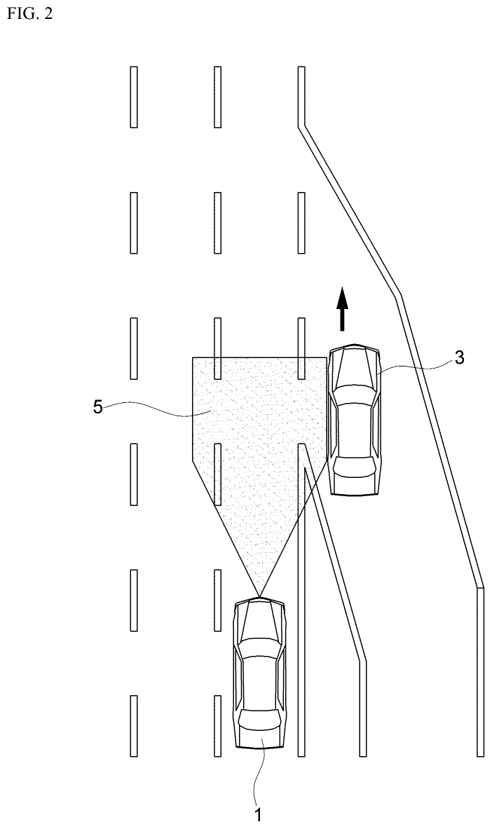

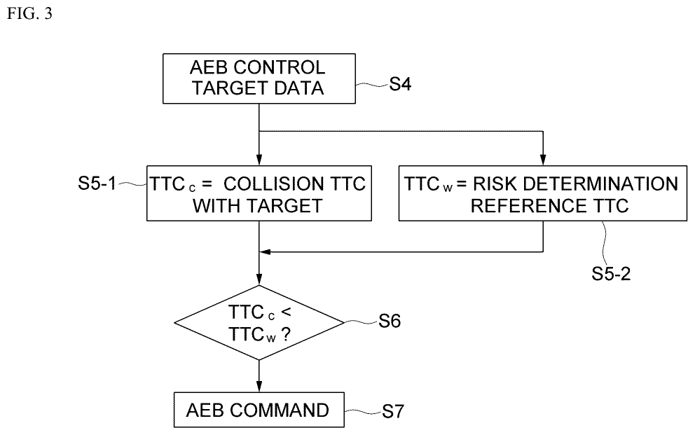

FIG. 2 is a diagram illustrating an example of control target selection in a general autonomous emergency braking method, and FIG. 3 is a flowchart illustrating a general autonomous emergency braking method.

As shown in FIG. 2, a vehicle 3 in an merging lane is a vehicle in a lane next to a driving vehicle 1 and is therefore not included in a preset autonomous emergency braking function operation range 5, so the vehicle 3 is not a subject for operating the autonomous emergency braking function.

In other words, according to the autonomous emergency braking method, it is not possible to distinguish between a road with a high risk of an accident and a general road.

Meanwhile, in the general autonomous emergency braking method, as shown in FIG. 3, after autonomous emergency braking (AEB) control target data is selected through the control target selection process of FIG. 1 (S4), a collision is predicted based on time-to-collision (TTC), a collision TTC (TTC_{c}) with a target is calculated through dynamic information, such as a relative distance to the selected autonomous emergency braking control target, a relative speed, and the like (S5-1), the calculated collision TTC (TTC_{c}) with the target is compared with a preset risk determination reference TTC (TTC_{w}) (S5-2), and if the collision TTC (TTC_{c}) with the target is smaller than the risk determination reference TTC (TTC_{w}), it is determined as a risk (S6) and a warning and braking command is issued (S7).

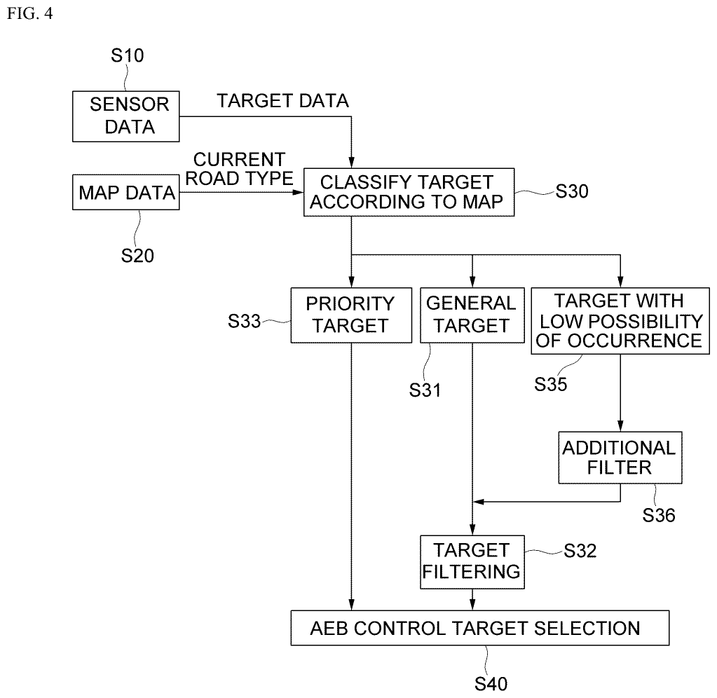

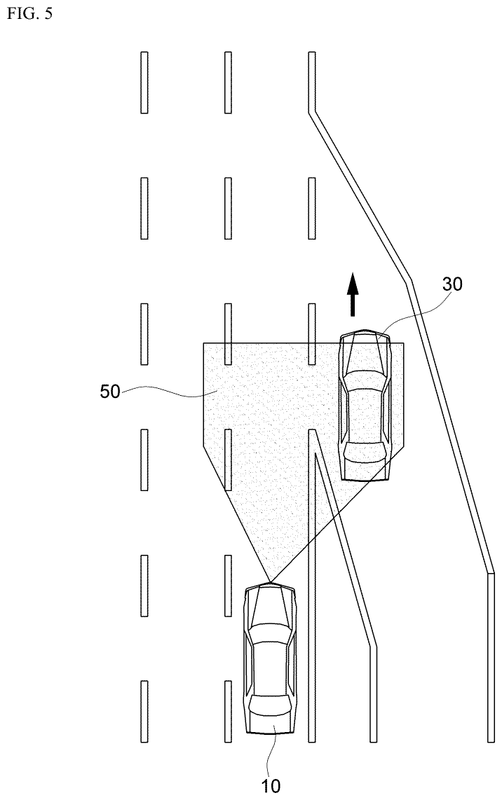

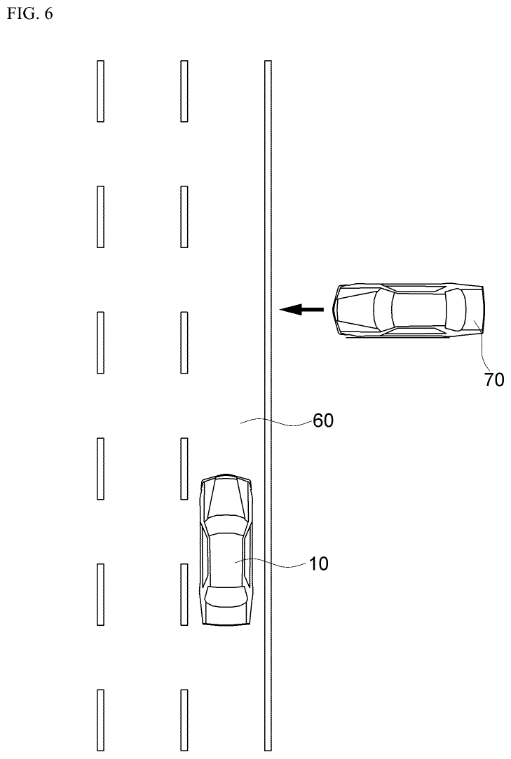

FIG. 4 is a flowchart illustrating a control target selection process in an autonomous emergency braking method based on map data according to the present disclosure, FIG. 5 is a diagram illustrating an example of control target selection in an autonomous emergency braking method based on map data according to the present disclosure, and FIG. 6 is a diagram illustrating another example of control target selection in an autonomous emergency braking method based on map data according to the present disclosure.

In the autonomous emergency braking method based on map data according to the present disclosure, as shown in FIG. 4, the controller receives control target information (target data) for autonomous emergency braking through sensor data from a sensor mounted on the vehicle (S10), the controller receives real-time driving road type information (current road type) through map data (map/navigation) mounted on the vehicle (S20), and the controller classifies the control target according to the driving road type of the map data (S30) and then selects an autonomous emergency braking control target (S40).

At this time, the controller may classify the control target into a general target, a priority target, and a target with a low possibility of occurrence (S31, S33, S35) according to the driving road type.

Specifically, when the control target is a general target (S31), the controller may filter data of the control target (S32) and determine whether the control target is a normal autonomous emergency braking control target, and if the control target is determined to be a normal autonomous emergency braking control target, the controller may perform autonomous emergency braking control target selection (S40).

In addition, when the control target is a priority target (S33), the controller may alleviate data filtering of the control target and determine whether the control target is a normal autonomous emergency braking control target. When the control target is determined to be a normal autonomous emergency braking control target, the controller may perform autonomous emergency braking control target selection (S40).

For example, as shown in FIG. 5, when it is confirmed that it is a lane merging point through map data mounted on the driving vehicle 10, the vehicle 30 in the merging lane is selected as a priority target, and autonomous emergency braking may be performed by alleviating filtering on the priority target.

That is, since the vehicle 30 in the merging lane is included in a preset autonomous emergency braking function operation range 50, the autonomous emergency braking function is activated.

In addition, when the control target is a target with a low possibility of occurrence (S35), the controller may strengthen data filtering of the control target (adds a target selection filter) (S36) and determine whether the control target is a normal autonomous emergency braking control target, and when the control target is determined to be a normal autonomous emergency braking control target, the controller may perfrom autonomous emergency braking control target selection (S40).

For example, as shown in FIG. 6, a target of a crossing vehicle 70 crossing a lane on the highway 60 is highly likely to be due to misrecognition, and thus, the target may be selected as a target with a low possibility of occurrence through map data.

By strengthening the filter for the target with a low possibility of occurrence, the misrecognition rate is reduced.

In addition, in the case of the target with a low possibility of occurrence, a braking point may be set to be slow.

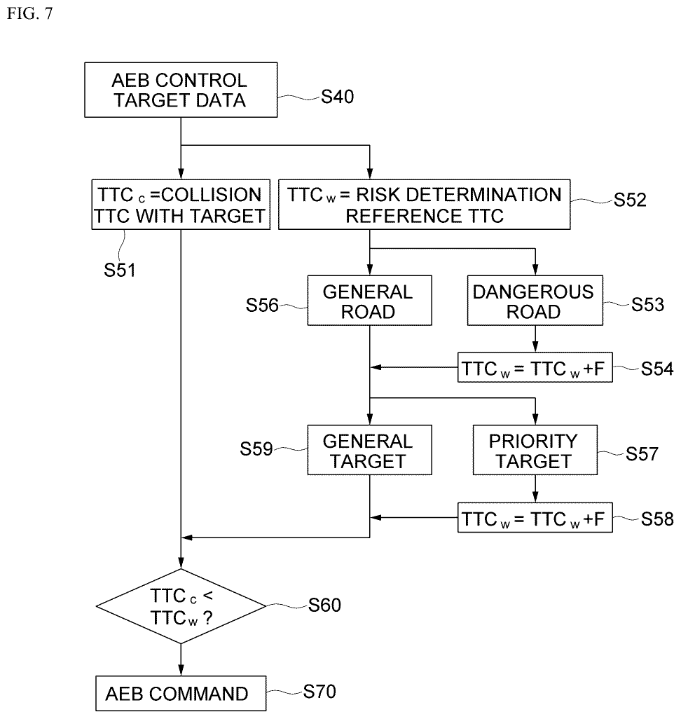

FIG. 7 is a flowchart illustrating an autonomous emergency braking method based on map data according to the present disclosure.

After selecting autonomous emergency braking (AEB) control target data through the control target selection process of FIG. 4 (S40), the controller predicts a collision based on time-to-collision (TTC), calculates a collision TTC (TTC_{c}) with a target through dynamic information, such as a relative distance to the selected autonomous emergency braking control target, a relative speed, and the like (S51), and compares the calculated collision TTC (TTC_{c}) with the target with a preset risk determination reference TTC (TTC_{w}) (S52), and if the collision TTC (TTC_{c}) with the target is smaller than the risk determination reference TTC (TTC_{w}), the controller determines it as a risk (S60) and issues a warning and braking command (S70).

At this time, the driving road may be classified into a dangerous road and a general road according to the risk determination reference TTC (TTC_{w}) (S53 and S56).

In other words, in the present disclosure, the degree of pavement of the driving road is divided into stages through map data and different braking tuning values are used according to each road situation.

Specifically, when the driving road is a dangerous road (S53), the controller may set a warning time faster than when the driving road is a general road (S56) by adding a tuning value F to the risk determination reference TTC (TTC_{w}) (S54).

For example, if the driving road is a downward slope, a braking distance may be lengthened even if the same level of braking is performed.

Therefore, if the road on which the vehicle is currently driving is a downward slope, the road may be determined as a dangerous road and an autonomous emergency braking (AEB) operation point may be set to be earlier.

In addition, when the driving road is a general road (S56), the controller may classify the autonomous emergency braking control target selected in the control target selection process of FIG. 4 into a priority target and a general target (S57 and S59).

Specifically, when the selected autonomous emergency braking control target is a priority target (S57), the controller may add the tuning value F to the risk determination reference TTC (TTC_{w}) (S58) to set a warning time to be earlier than that of the case of a general target (S59).

For example, in a child protection zone, a children pedestrian is a frequent target.

Therefore, it is possible to quickly set the autonomous emergency braking operation point for the child target by designating the child target as a priority target.

In this manner, the controller performs collision prediction based on the selected autonomous emergency braking control target data based on TTC, and if the collision TTC (TTC_{c}) with the target calculated through dynamic information including a relative distance to the selected autonomous emergency braking control target, a relative speed, and the like is smaller than the preset risk determination reference TTC (TTC_{w}), the controller determines a risk and performs warning and braking.

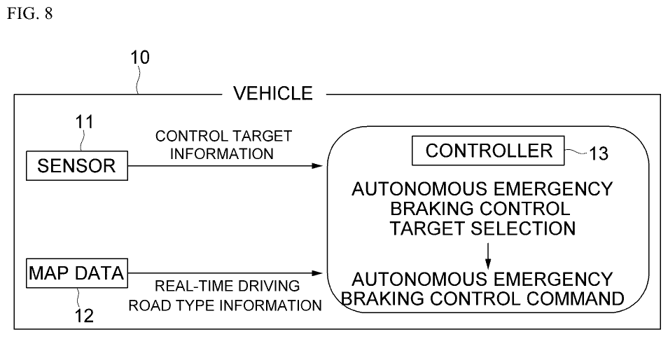

FIG. 8 is a schematic configuration diagram of a system for implementing an autonomous emergency braking method based on map data according to the present disclosure.

The system for implementing an autonomous emergency braking method based on map data according to the present disclosure includes a controller 13 in which a program configured to receive information on a control target for autonomous emergency braking through a sensor 11 mounted on a vehicle 10, receive real-time driving road type information (current road type) through map data (map/navigation) 12 mounted on the vehicle 10, select an autonomous emergency braking control target through the process of FIG. 4 described above, and then issue an autonomous emergency braking command through the process of FIG. 7 on the selected autonomous emergency braking control target is installed.

Meanwhile, in a non-transitory computer-readable recording medium on which a program according to the present disclosure is recorded, a program for a controller, when executed by a processor of the controller, to receive information (target data) of a control target for autonomous emergency braking through sensor data from a sensor mounted in a vehicle (S10), receive real-time driving road type information (current road type) through map data (map/navigation) mounted in the vehicle (S20), classify the control target according to a driving road type of the map data (S30), select an autonomous emergency braking control target (S40), performs a collision prediction on the selected autonomous emergency braking control target data based on a TTC, calculate a collision TTC (TTC_{c}) with a target through dynamic information, such as a relative distance to the selected autonomous emergency braking control target, a relative speed, and the like (S51), compare the calculated collision TTC (TTC_{c}) with the target with a preset risk determination reference TTC (TTC_{w}) (S52), determine a risk if the collision TTC (TTC_{c}) with the target is smaller than the risk determination reference TTC (TTC_{w}) (S60), and issue a warning and braking command (S70) is recorded.

Alternatively, in the non-transitory computer-readable recording medium on which a program according to the present disclosure is recorded, a program for a controller, when executed by a processor of the controller, to receive information (target data) of a control target for autonomous emergency braking through sensor data from a sensor mounted in a vehicle (S10), receive real-time driving road type information (current road type) through map data (map/navigation) mounted in the vehicle (S20), classify the control target into a general target, a priority target, and a target with a low possibility of occurrence (S31, S33, S35) according to the driving road type, select an autonomous emergency braking control target (S40), classify the driving road into a dangerous road and a general road (S53 and S56) according to the risk determination reference TTC (TTC_{w}) based on the selected autonomous emergency braking control target data, calculate a collision TTC (TTC_{c}) with a target through dynamic information, such as a relative distance to the selected autonomous emergency braking control target, a relative speed, and the like (S51), compare the calculated collision TTC (TTC_{c}) with the target with a preset risk determination reference TTC (TTC_{w}) (S52), determine a risk if the collision TTC (TTC_{c}) with the target is smaller than the risk determination reference TTC (TTC_{w}) (S60), and issue a warning and braking command (S70) may be recorded.

The embodiments of the present disclosure may be described in terms of functional block components and various processing steps.

Such functional blocks may be realized by any number of hardware and/or software components configured to perform the specified functions.

For example, embodiments may employ various integrated circuit (IC) components, e.g., memory elements, processing elements, logic elements, look-up tables, and the like, which may carry out a variety of functions under the control of one or more microprocessors or other control devices.

Similarly, where the elements are implemented using software programming or software elements, the present embodiments may be implemented with any programming or scripting language such as C, C++, Java, assembler language, or the like, with the various algorithms being implemented with any combination of data structures, objects, processes, routines or other programming elements.

Functional aspects may be implemented in algorithms that are executed on one or more processors.

Furthermore, the embodiments described herein could employ any number of conventional techniques for electronics configuration, signal processing and/or control, data processing and the like.

Here, each block of flowcharts and the combination of flowchart diagrams may be performed by computer program instructions.

Since computer program instructions may be mounted in a processor of a universal computer, a special computer or other programmable data processing equipment, instructions performed through a processor of a computer or other programmable data processing equipment generates means for performing functions described in block(s) of the flowcharts.

Since the computer program instructions may be stored in a computer or a computer readable memory capable of orienting a computer or other programmable data processing equipment to implement functions in a specific scheme, instructions stored in the computer or the computer readable memory may produce manufacturing articles involving an instruction means for executing functions described in block(s) of flowcharts.

Because the computer program instructions may be mounted on a computer or other programmable data processing equipment, a series of operations are performed in the computer or other programmable data processing equipment to create a process executed by the computer such that instructions performing the computer or other programmable data processing equipment may provide operations for executing functions described in block(s) of flowcharts.

Further, each block may indicate a part of a module, a segment, or a code including at least one executable instruction for executing specific logical function(s).

It should be noticed that several execution examples may generate functions described in blocks out of an order.

For example, two continuously shown blocks may be simultaneously performed, and the blocks may be performed in a converse order according to corresponding functions.

The present disclosure described above is not limited to the embodiments described above and the accompanying drawings, and it is obvious to those skilled in the art to which the present disclosure pertains that various substitutions, modifications, and changes are may be made without departing from the technical spirit of the present disclosure.

What is claimed is:

1. An autonomous emergency braking method based on map data, wherein
a controller receives information (target data) of a control target for autonomous emergency braking through sensor data from a sensor mounted in a vehicle, receives real-time driving road type information (current road type) through map data (map/navigation) mounted in the vehicle, classifies the control target according to a driving road type of the map data,
selects an autonomous emergency braking control target,
performs a collision prediction on the selected autonomous emergency braking control target data based on time-to-collision (TTC),
calculates a collision TTC (TTC_{c}) with a target through dynamic information including a relative distance to the selected autonomous emergency braking control target and a relative speed, compares the calculated collision TTC (TTC_{c}) with the target with a preset risk determination reference TTC (TTC_{w}), determines a risk when the collision TTC (TTC_{c}) with the target is smaller than the risk determination reference TTC (TTC_{w}), and issues a warning and braking command.

2. The autonomous emergency braking method of claim 1, wherein the controller classifies the control target into a general target, a priority target, and a target with a low possibility of occurrence according to the driving road type.

3. The autonomous emergency braking method of claim 2, wherein, when the control target is the general target, the controller filters data of the control target and determines whether the control target is a normal autonomous emergency braking control target, and when the control target is determined to be the normal autonomous emergency braking control target, the controller performs autonomous emergency braking control target selection.

4. The autonomous emergency braking method of claim 2, wherein, when the control target is the priority target, the controller alleviates data filtering of the control target and determines whether the control target is a normal autonomous emergency braking control target, and when the control target is determined to be the normal autonomous emergency braking control target, the controller performs autonomous emergency braking control target selection.

5. The autonomous emergency braking method of claim 2, wherein, when the control target is the target with a low possibility of occurrence, the controller strengthens data filtering of the control target (adds a target selection filter) and determines whether the control target is a normal autonomous emergency braking control target, and when the control target is determined to be the normal autonomous emergency braking control target, the controller performs autonomous emergency braking control target selection.

6. The autonomous emergency braking method of claim 1, wherein the controller classifies the driving road into a dangerous road and a general road according to the risk determination reference (TTC) (TTC_{w}) based on the selected autonomous emergency braking control target data.

7. The autonomous emergency braking method of claim 6, wherein, when the driving road is the dangerous road, the controller sets a warning time point earlier than that of the general road by adding a tuning value F to the risk determination reference TTC (TTC_{w}).

8. The autonomous emergency braking method of claim 6, wherein, when the driving road is the general road, the controller classifies the selected autonomous emergency braking control target into a priority target and a general target.

9. The autonomous emergency braking method of claim 8, wherein, when the selected autonomous emergency braking control target is the priority target, the controller sets a warning time point earlier than that of the general target by adding a tuning value F to the risk determination reference TTC (TTC_{w}).

10. An autonomous emergency braking method based on map data, wherein a controller receives information (target data) of a control target for autonomous emergency braking through sensor data from a sensor mounted in a vehicle, receives real-time driving road type information (current road type) through map data (map/navigation) mounted in the vehicle, and
classifies the control target into a general target, a priority target, and a target with a low possibility of occurrence according to the driving road type, and
when the control target is a priority target, the controller alleviates data filtering of the control target and determines whether the control target is a normal autonomous emergency braking control target, and when the control target is determined to be a normal autonomous emergency braking control target, the controller performs autonomous emergency braking control target selection.

11. The autonomous emergency braking method of claim 10, wherein
the controller performs collision prediction on the selected autonomous emergency braking control target data based on time-to-collision (TTC),
calculates a collision TTC (TTC_{c}) with a target through dynamic information including a relative distance to the selected autonomous emergency braking control target and a relative speed, and compares the calculated collision TTC (TTC_{c}) with the target with a preset risk determination reference TTC (TTC_{w}), and when the collision TTC (TTC_{c}) with the target is smaller than the risk determination reference TTC (TTC_{w}), the controller determines it as a risk and issues a warning and braking command.

12. The autonomous emergency braking method of claim 11, wherein
the controller classifies the driving road into a dangerous road and a general road according to the risk determination reference TTC (TTC_{w}) based on the selected autonomous emergency braking control target data, and
when the driving road is the dangerous road, the controller sets a warning time point earlier than that of the general road by adding a tuning value F to the risk determination reference TTC (TTC_{w}).

13. The autonomous emergency braking method of claim 12, wherein,
when the driving road is a general road, the controller classifies the selected autonomous emergency braking control target into a priority target and a general target, and
when the selected autonomous emergency braking control target is the priority target, the controller sets the warning time point earlier than that of the general target by adding a tuning value F to the risk determination reference TTC (TTC_{w}).

14. An autonomous emergency braking method based on map data, wherein a controller receives information (target data) of a control target for autonomous emergency braking through sensor data from a sensor mounted in a vehicle, receives real-time driving road type information (current road type) through map data (map/navigation) mounted in the vehicle,
classifies the control target into a general target, a priority target, and a target with a low possibility of occurrence according to the driving road type, and
when the control target is the target with a low possibility of occurrence, the controller strengthens data filtering of the control target (adds a target selection filter) and determines whether the control target is a normal autonomous emergency braking control target, and when the control target is determined to be the normal autonomous emergency braking control target, the controller performs autonomous emergency braking control target selection.

15. The autonomous emergency braking method of claim 14, wherein
the controller performs a collision prediction on the selected autonomous emergency braking control target data based on time-to-collision (TTC),
calculates a collision TTC (TTC_{c}) with a target through dynamic information including a relative distance to the selected autonomous emergency braking control target and a relative speed, compares the calculated collision TTC (TTC_{c}) with the target with a preset risk determination reference TTC (TTC_{w}), determines a risk when the collision TTC (TTC_{c}) with the target is smaller than the risk determination reference TTC (TTC_{w}), and issues a warning and braking command.

16. The autonomous emergency braking method of claim 15, wherein
the controller classifies the driving road into a dangerous road and a general road according to the risk determination reference TTC (TTC_{w}) based on the selected autonomous emergency braking control target data, and
when the driving road is the dangerous road, the controller sets a warning time point earlier than that of the general road by adding a tuning value F to the risk determination reference TTC (TTC_{w}).

17. The autonomous emergency braking method of claim 16, wherein,
when the driving road is a general road, the controller classifies the selected autonomous emergency braking control target into a priority target and a general target, and
when the selected autonomous emergency braking control target is the priority target, the controller sets the warning time point earlier than that of the general target by adding a tuning value F to the risk determination reference TTC (TTC_{w}).
